(19) United States
(12) Patent Application Publication
(10) Pub. No.: US 2006/0125205 A1
(43) Pub. Date: Jun. 15, 2006

(54) Front wheel drive mechanism for bicycle

(75) Inventor: Kuo-Yen Lai, Hsinchu County (TW)

Correspondence Address: BACON & THOMAS, PLLC, 625 SLATERS LANE, FOURTH FLOOR, ALEXANDRIA, VA, 22314, US

(73) Assignee: Biketech Innovation Co., Ltd., Taipei (TW)

(21) Appl. No.: 11/297,401

(22) Filed: Dec. 9, 2005

(30) Foreign Application Priority Data
Dec. 9, 2004 (TW) 093138191

(51) Int. Cl. B62M 1/02

(52) U.S. Cl. 280/259

(57) ABSTRACT

A front wheel drive mechanism is mounted in a bicycle including a front wheel and two pedals adapted to propel by feet. The mechanism comprises a first transmission assembly connected to the pedals, provided at one side of front wheel, and connected to main frame; a second transmission assembly connected to the front wheel, provided at the other side of the front wheel, and connected to steering assembly; and a coupling device with limited swing capability adapted to transmit pedaling force from the first transmission assembly to the second transmission assembly. The coupling device is interconnected the first and the second transmission assemblies for allowing the first and the second transmission assemblies to dispose in a non-parallel relationship when the bicycle turns curves with the pedaling force transmitted from the first transmission assembly to the front wheel via the second transmission assembly.

### BACKGROUND OF THE INVENTION

1. Field of Invention

The present invention relates to drive mechanisms for bicycle and more particularly to a front wheel drive mechanism adapted to mount in a bicycle with a recumbent back, a tricycle, or a folding bicycle.

2. Description of Related Art

Conventionally, front wheel of a bicycle is responsible for steering and rear wheel thereof coupled to a drive mechanism is responsible for driving. Such design aims at preventing steering from being interfered by drive mechanism and configuring the front wheel as an idler wheel only. In another aspect, bicycles have evolved from simple transportation tool to leisure tool. Thus, bicycles with a recumbent back, tricycles, or folding bicycles are available in recent years. For example, a distance from pedals to hub of rear wheel of a bicycle with a recumbent back is relatively longer than that of a typical bicycle. This can decrease drive efficiency and thus a bicycle rider may pedal laboriously. Also, a long drive chain is visually unattractive for the bicycle with a recumbent back. Further, the unfoldable long drive chain and two chain wheels may compromise the desired folding effect of such bicycle since only several percentage of bicycle length can be decreased after folding. This is a contrast to a typical folding bicycle which is adapted to decrease its length to about half after folding. In this regard, the typical rear wheel drive is neither applicable to bicycles with a recumbent back nor applicable to folding bicycles.

For the recently popular tricycle, it typically comprises an idler front wheel responsible for steering and two rear wheels responsible for driving. Note that another type of tricycle has one rear wheel as drive wheel and the other rear wheel as idler wheel. It is known that for an automobile in turning curves the outer rear wheel turns faster than the inner rear wheel. Thus, a differential gear is mounted in rear axles for allowing such difference in the rear axle speeds while turning curves. However, very few types of tricycle have differential gear due to cost, weight, etc. Thus, rear wheel of typical tricycle has the drawbacks of high wear, poor steering, etc. The drawback of poor steering still exists even if a tricycle is configured as one having one rear wheel as drive wheel and the other rear wheel as idler wheel. This is not safe. Thus, a need for improvement exists.

### SUMMARY OF THE INVENTION

It is therefore an object of the present invention to provide a drive mechanism for bicycle in which pedaling force is transmitted to front wheel without interfering with steering mechanism thereof. Thus, the front wheel is responsible for driving and steering and the rear wheel is configured as idler wheel only.

It is another object of the present invention to provide a front wheel drive mechanism for bicycle in which a drive efficiency is increased significantly by improving a transmission from pedals to front wheel such that a person may ride the bicycle in a labor saving manner.

It is yet another object of the present invention to provide a front wheel drive mechanism adapted to mount in a bicycle with a recumbent back or a folding bicycle in which length of typical drive chain is decreased significantly and the bicycle is aesthetic. For a folding bicycle incorporating the front wheel drive mechanism, its folding is more easy and convenient, and folded length thereof is even shorter than the conventional folding bicycle having a rear wheel drive mechanism.

It is a further object of the present invention to provide a front wheel drive mechanism adapted to mount in a tricycle in which both rear wheels are configured as idler wheels, bearings are mounted at one end of an axle connecting one rear wheel and the other end of the axle connecting the other rear wheel respectively, and for example, the outer rear wheel turns faster than the inner rear wheel as the tricycle turns curves and such difference in the rear axle speeds while turning curves is allowed by the present invention. As a result, drawbacks including high wear and poor steering associated with the rear wheel drive of typical tricycle are substantially eliminated.

To achieve the above and other objects, the present invention provides a front wheel drive mechanism mounted in a bicycle including a front wheel, a pair of pedals adapted to propel by feet, a main frame mounted with the pedals, and a steering assembly mounted on the front wheel for steering same, the steering assembly being adapted to pivot relative to the main frame, the front wheel drive mechanism comprising a first transmission assembly connected to the pedals, provided at one side of the front wheel, and connected to the main frame; a second transmission assembly connected to the front wheel, provided at the other side of the front wheel, and connected to the steering assembly; and a coupling device with limited swing capability adapted to transmit pedaling force from the first transmission assembly to the second transmission assembly. The coupling device is interconnected the first and the second transmission assemblies for allowing the first and the second transmission assemblies to dispose in a non-parallel relationship when the bicycle turns curves with the pedaling force transmitted from the first transmission assembly to the front wheel via the second transmission assembly.

The above and other objects, features and advantages of the present invention will become apparent from the following detailed description taken with the accompanying drawings.

### BRIEF DESCRIPTION OF THE DRAWINGS

FIG. 1 is a front view of bicycle incorporating a first preferred embodiment of front wheel drive mechanism according to the invention;

FIG. 2 is a side view of the bicycle shown in FIG. 1;

FIG. 3 is a perspective view of a first configuration of coupling device mounted in the front wheel drive mechanism;

FIG. 4 is a front view of a second configuration of coupling device mounted in the front wheel drive mechanism;

FIG. 5 is a side view of a front portion of bicycle incorporating a second preferred embodiment of front wheel drive mechanism according to the invention;

FIG. 6 is a side view of bicycle incorporating a third preferred embodiment of front wheel drive mechanism according to the invention; and

FIG. 7 is a front view of tricycle incorporating the first preferred embodiment of front wheel drive mechanism according to the invention.

### DETAILED DESCRIPTION OF THE INVENTION

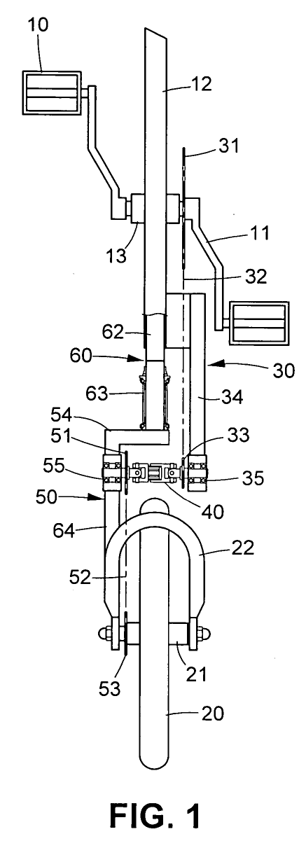

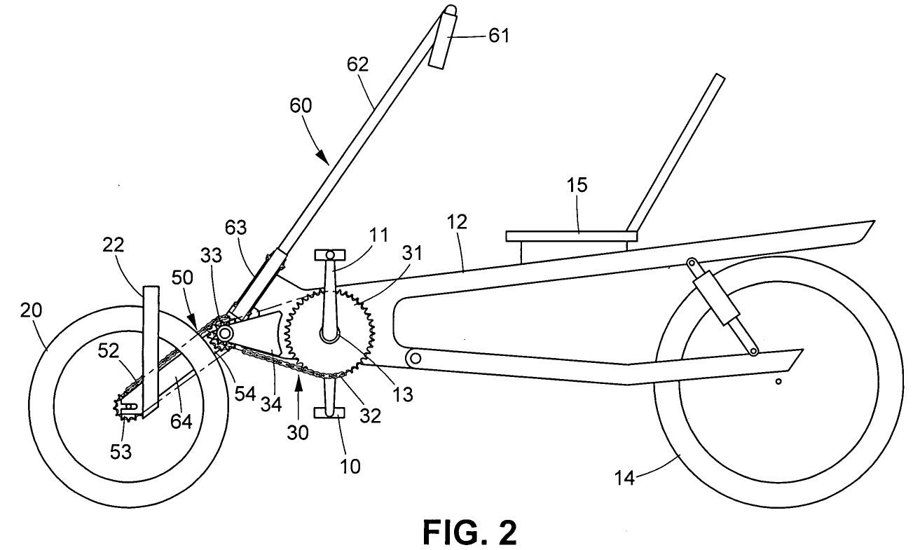

Referring to FIGS. 1 and 2, a bicycle incorporating a first preferred embodiment of front wheel drive mechanism according to the invention is shown. The bicycle comprises a pair of pedals 10 to be propelled by feet, a first transmission assembly 30 connected to the pedals 10, provided at one side of a front wheel 20, and connected to a main frame 12, a second transmission assembly 50 connected to the front wheel 20, provided at the other side of the front wheel 20, and connected to a steering assembly 60, and a coupling device 40 with limited swing capability adapted to transmit pedaling force from the first transmission assembly 30 to the second transmission assembly 50.

The pedals 10 are prior art components of bicycle and each is mounted at an open end of a crank 11. The crank 11 at either side of the front wheel 20 passes a bottom bracket 13 fixedly connected to the main frame 12 to the other side of the front wheel 20. The main frame 12 is adapted to assemble with the bottom bracket 13, the rear wheel 14, and the saddle 15. However, a detailed description of the main frame 12, the cranks 11, the bottom bracket 13, the rear wheel 14, and the saddle 15 is omitted herein because they are prior art devices.

The first transmission assembly 30 comprises a drive chain wheel 31 fixedly connected to the cranks 11 and being adapted to turn by propelling the pedals 10, and a first chain 32 coupled between the drive chain wheel 31 and a first idler wheel 33 for transmitting driving force. The first idler wheel 33 in cooperation with the first chain 32 is implemented as a chain wheel. The first idler wheel 33 is mounted on a first arm 34 having first bearings 35 with the first idler wheel 33 rotatably mounted on an axle interconnected the first idler wheel 33 and a center of the first bearings 35. The first arm 34 is adapted to selectively mount on a desired position of the main frame 12 as long as no interference with the operation of the first chain 32 is made.

The second transmission assembly 50 comprises an idler chain wheel 53 fixedly connected to an axle 21 of the front wheel 20 and being adapted to co-rotate with the front wheel 20, a second chain 52 coupled between the idler chain wheel 53 and a second idler wheel 51 for transmitting driving force. The second idler wheel 51 in cooperation with the second chain 52 is implemented as a chain wheel. The second idler wheel 51 is mounted on a second arm 54 having second bearings 55 with the second idler wheel 51 rotatably mounted on an axle interconnected the second idler wheel 51 and a center of the second bearings 55. The second arm 54 is adapted to selectively mount on a desired position of the steering assembly 60 as long as no interference with the operation of the second chain 52 is made.

The steering assembly 60 comprises, from top to bottom, a pair of handlebars 61, an upper head tube 62, a lower head tube 63, and a fork 64. A bicycle rider may hold the handlebars 61 for steering. The lower head tube 63 is connected to the main frame 12 and is adapted to permit the steering assembly 60 to pivot about the main frame 12. The upper head tube 62 is interconnected the handlebars 61 and the lower head tube 63. The fork 64 is interconnected the lower head tube 63 and the front wheel 20. However, a detailed description of the steering assembly 60 is omitted herein because it is a prior art device.

In the invention the fork 64 may be replaced by the second arm 54 which is thus connected to the lower head tube 63. The second arm 54 is further downward extended to mount at both ends of axle 21 of the front wheel 20. Further, a U-shaped member 22 has its both ends assembled with both ends of axle 21 of the front wheel 20 so as to enhance stability while driving.

Both the first transmission assembly 30 and the second transmission assembly 50 are implemented as chain wheel and chain assembly. But other known mechanisms such as gear and shaft assembly are also contemplated by the invention.

Moreover, the first arm 34 may be altered to connect to the steering assembly 60. The second arm 54 thus may be altered to connect to the main frame 12. Both substitutions are also contemplated by the invention.

The coupling device 40 is interconnected the first idler wheel 33 and the second idler wheel 51. Also, the coupling device 40 is adapted to permit the first idler wheel 33 and the second idler wheel 51 to dispose not in parallel relationship when the bicycle turns curves without interfering with driving force transmitted from the first idler wheel 33 to the second idler wheel 51.

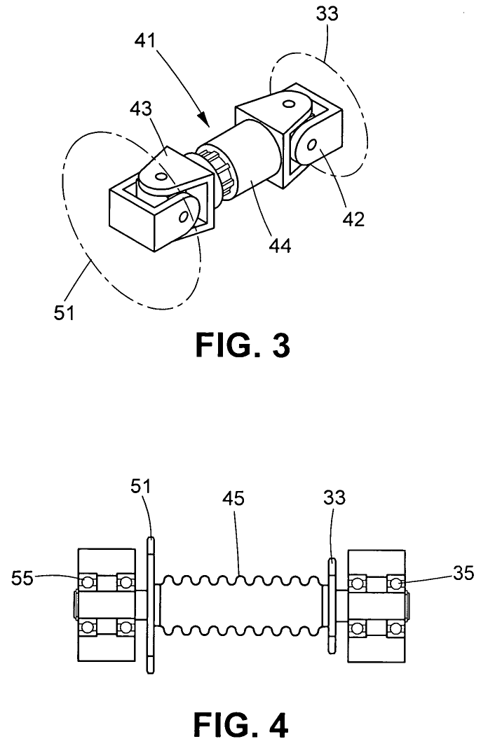

The coupling device 40 may be implemented as a universal joint 41 as shown in FIG. 3 or a flexible coupling 45 as shown in FIG. 4. The universal joint 41 comprises a first coupling 42 at one end connected to the first idler wheel 33, a second coupling 43 at the other end connected to the second idler wheel 51, and an intermediate bar 44 interconnected the first and second couplings 42 and 43. The universal joint 41 thus can dispose the first idler wheel 33 and the second idler wheel 51 in a non-parallel relationship when the bicycle turns curves without interfering with driving force transmitted from the first idler wheel 33 to the second idler wheel 51. The flexible coupling 45 has both ends connected to both the first idler wheel 33 and the second idler wheel 51. The flexible coupling 45 thus also can dispose the first idler wheel 33 and the second idler wheel 51 in a non-parallel relationship when the bicycle turns curves without interfering with driving force transmitted from the first idler wheel 33 to the second idler wheel 51.

Driving force is generated by a rider propelling the pedals 10. The force is then transmitted to the coupling device 40 via the first transmission assembly 30. Also, both the first transmission assembly 30 and the second transmission assembly 50 may dispose in a non-parallel relationship when the bicycle turns curves. Finally, the force is transmitted to the front wheel 20 via the coupling device 40 and the second transmission assembly 50 for propelling the bicycle forward. Both the coupling device 40 and the front wheel 20 may deflect to the same angle as a rider turns the steering assembly 60. As a result, the front wheel drive mechanism of the invention does not interfere with the operation of the steering assembly 60.

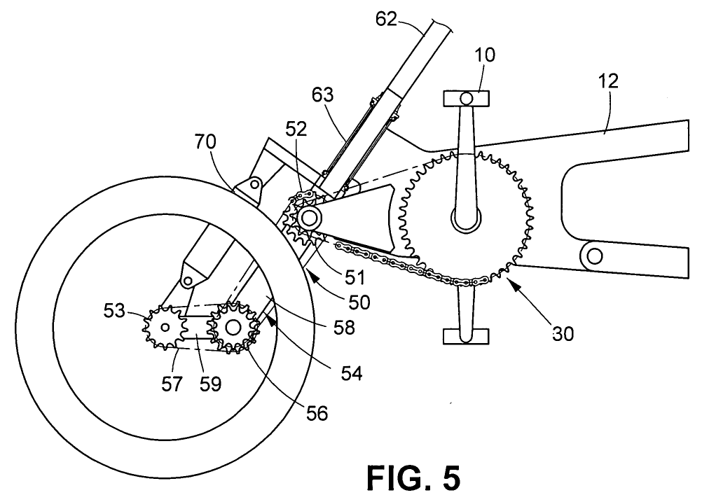

Referring to FIG. 5, a bicycle incorporating a second preferred embodiment of front wheel drive mechanism according to the invention is shown. In this embodiment, force is transmitted from the second idler wheel 51 to the idler chain wheel 53 via the second chain 52, an additional idler wheel means 56, and an additional third chain 57. Also, the second arm 54 is replaced by a toggle joint comprised of first and second bars 58 and 59 with the idler wheel means 56 mounted in the joining portion of the first and second bars 58 and 59. A height difference thus exists between the higher second idler wheel 51 and the lower idler chain wheel 53. A shock absorber 70 mounted between the hub of the front wheel 20 and the lower head tube 63 (or the main frame 12) for absorbing the force of shocks and jarring generated by the riding bicycle is also contemplated by this embodiment.

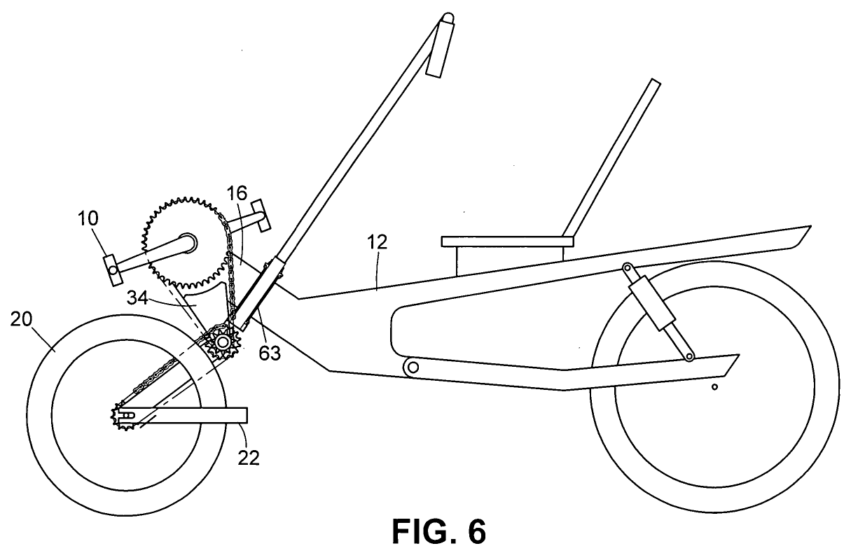

Referring to FIG. 6, bicycle incorporating a third preferred embodiment of front wheel drive mechanism according to the invention is shown. The third preferred embodiment substantially has same structure as the first preferred embodiment. The differences between the first and the third preferred embodiments, i.e., the characteristics of the third preferred embodiment are detailed below. The main frame 12 has its forward portion further extended out of the lower head tube 63. The extended portion is mounted with the pedals 10 and a mounting member 16 of the first arm 34. That is, the pedals 10 are mounted in front of the lower head tube 63. This embodiment allows a rider to fully stretch his/her feet while recumbently riding a bicycle. The U-shaped member 22 may be mounted horizontally as shown or in any other position of the bicycle as long as the operation of the pedals 10 is not interfered.

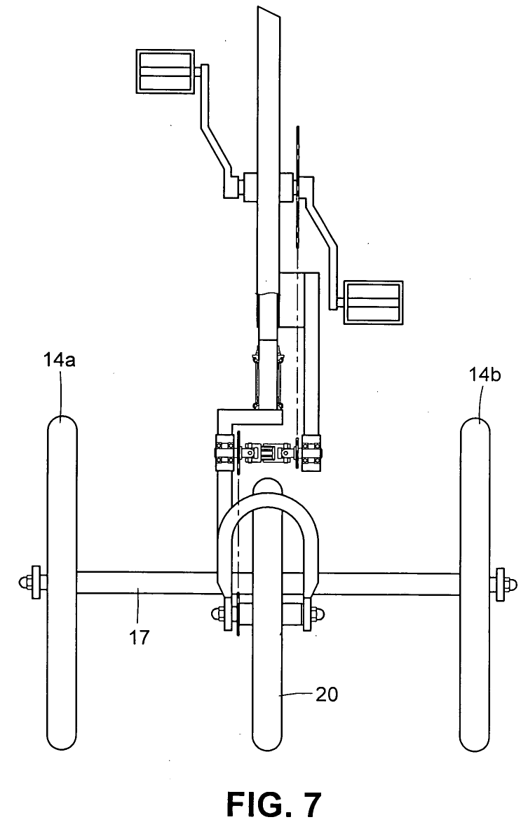

Referring to FIG. 7, a tricycle incorporating the first preferred embodiment of front wheel drive mechanism according to the invention is shown. The front wheel 20 is configured as one capable of steering and driving and both the rear wheels 14a and 14b are configured as idler wheels. Further, bearings are mounted at one end of an axle 17 connecting one rear wheel 14a and the other end of the axle 17 connecting the other rear wheel 14b respectively. Thus, both the rear wheels 14a and 14b may turn smoothly. In one example, the outer rear wheel 14a turns faster than the inner rear wheel 14b as the tricycle turns curves and such difference in the rear axle 17 speeds while turning curves is allowed by the invention. This embodiment substantially eliminates the drawbacks of high wear, poor steering, etc. associated with the rear wheel drive of typical tricycle.

While the invention herein disclosed has been described by means of specific embodiments, numerous modifications and variations could be made thereto by those skilled in the art without departing from the scope and spirit of the invention set forth in the claims.

What is claimed is:

1. A front wheel drive mechanism mounted in a bicycle including a front wheel, a pair of pedals adapted to propel by feet, a main frame mounted with the pedals, and a steering assembly mounted on the front wheel for steering same, the steering assembly being adapted to pivot relative to the main frame, the front wheel drive mechanism comprising:
a first transmission assembly connected to the pedals, provided at one side of the front wheel, and connected to the main frame;
a second transmission assembly connected to the front wheel, provided at the other side of the front wheel, and connected to the steering assembly; and
a coupling device with limited swing capability adapted to transmit pedaling force from the first transmission assembly to the second transmission assembly, the coupling device being interconnected the first and the second transmission assemblies for allowing the first and the second transmission assemblies to dispose in a non-parallel relationship when the bicycle turns curves with the pedaling force transmitted from the first transmission assembly to the front wheel via the second transmission assembly.

2. The front wheel drive mechanism of claim 1, wherein the first transmission assembly includes a drive chain wheel adapted to turn by propelling the pedals, a first arm fixedly connected to the main frame, a first idler wheel mounted on the first arm, and a first chain coupled between the drive chain wheel and the first idler wheel for transmitting the pedaling force.

3. The front wheel drive mechanism of claim 1, wherein the second transmission assembly includes an idler chain wheel adapted to co-rotate with the front wheel, a second arm fixedly connected to the steering assembly, a second idler wheel mounted on the second arm, and a second chain coupled between the idler chain wheel and the second idler wheel for transmitting the pedaling force.

4. The front wheel drive mechanism of claim 1, wherein the coupling device is a universal joint including a first coupling at one end connected to the first transmission assembly, a second coupling at the other end connected to the second transmission assembly, and an intermediate bar interconnected the first and second couplings.

5. The front wheel drive mechanism of claim 1, wherein the coupling device a flexible coupling having both ends connected to the first and the second transmission assemblies respectively.

6. The front wheel drive mechanism of claim 1, wherein the main frame includes a forward portion extended in front of the steering assembly with the pedals mounted thereon.

7. The front wheel drive mechanism of claim 3, wherein the second transmission assembly further comprises idler wheel means and a third chain, wherein the pedaling force is transmitted from the second idler wheel to the idler chain wheel via the second chain, the idler wheel means, and the third chain, and further comprising a toggle joint including a first bar and a second bar with the idler wheel means mounted in a joining portion of the first and second bars.
